(19) United States
(12) Patent Application Publication
(10) Pub. No.: US 2026/0236292 A1
(43) Pub. Date: Aug. 13, 2026

(54) SYSTEMS AND METHODS FOR CLOUD MIGRATION WITH ARTIFICIAL INTELLIGENCE

(71) Applicant: JPMORGAN CHASE BANK, N.A., New York, NY (US)

(72) Inventors: Cheung Tak CHAN, Hong Kong (HK); Michael T. LEUNG, Sutton (GB); Deepa PRASANTH, Greenhithe (GB); Ivan LATUNOV, New York, NY (US); Sean MORAN, London (GB); Bismayan CHAKRABARTI, North Brunswick Township, NJ (US); Gregor A. KERR, Glasgow (GB)

(21) Appl. No.: 19/052,087

(22) Filed: Feb. 12, 2025

(51) Int. Cl. G06F 9/48; G06F 9/54

(52) U.S. Cl. CPC G06F 9/4875; G06F 9/547

(57) ABSTRACT

In some embodiments, the techniques described herein relate to a method including: receiving, at a cloud migration application and from a client device, a query, wherein the query includes an application identifier of an application to be migrated from the client device to a cloud based platform; retrieving, by the cloud migration application and from a context data store, context data; generating, by the cloud migration application, a prompt including the query and a migration profile including the context data as an embedding and provide the prompt to the machine learning model; receiving a request to search a vector database for a stored term similar to a query term and providing the stored term and a vector to the machine learning model; receiving an executable script in response to the migration profile; and executing the executable script to migrate the application from the client device to the cloud based platform.

### BACKGROUND

### 1. Field of The Invention

Aspects generally relate to systems and methods for cloud migration with artificial intelligence.

### 2. Description of the Related Art

Software applications commonly need to be deployed to a public cloud once they have been developed are ready for users, after updates are implemented, and when new features are implemented into the applications. However, migration from closed networks to a public cloud presents a number of challenges that a team of developers must address as they arise. This process is time-consuming and requires significant expertise and familiarity with code, the resources being used such as databases and references from different sources, and the application's purpose and function. Further, developers may introduce errors when migrating an application. There is thus a need to reduce or eliminate current the need for human operations in application migration. There is a need to improve large language models (“LLMs”) to accomplish consistent and efficient application migration. There is also a need to optimize agents to determine an optimal migration pattern and validate the migration. The use of LLMs will also allow launch failures of applications to be avoided or eliminated.

### SUMMARY

In some embodiments, the techniques described herein relate to a method including: receiving, at a cloud migration application, a query, wherein the query includes an application identifier; retrieving, by the cloud migration application and from a context data store, context data, wherein the context data is related to the application identifier; providing, by the cloud migration application, the query and the context data to a machine learning model as input to the machine learning model; receiving, at the cloud migration application and from the machine learning model, a request to search a private vector database associated with the cloud migration application; receiving, at the cloud migration application and from the machine learning model, a response to the query, wherein the response to the query is based on vector embeddings stored in the private vector database; and displaying, by the cloud migration application, the response to the query in a prompt.

In some embodiments, the techniques described herein relate to a method including: receiving, at a cloud migration application and from a client device, a query, wherein the query includes an application identifier of an application to be migrated from the client device to a cloud based platform; executing, by the cloud migration application, a retrieval augmented generation through a machine learning model in communication with the cloud migration application to index, retrieve, and augment the application; retrieving, by the cloud migration application and from a context data store, context data, wherein the context data is related to the application identifier; generating, by the cloud migration application, a prompt including the query and a migration profile including the context data as an embedding and provide the prompt to the machine learning model; receiving, at the cloud migration application and from the machine learning model, a request to search a private vector database for a stored term similar to a query term and providing the stored term and a vector to the machine learning model; receiving, at the cloud migration application and from the machine learning model, an executable script in response to the migration profile, the stored term, and the vector; and executing, by the cloud migration application on the client device, the executable script to migrate the application from the client device to the cloud based platform.

In some embodiments, the context data may include a public cloud capability and one or more constraints. In some embodiments, the request from the machine learning model may be received as a call to an application programming interface (API) of the cloud migration application. In some embodiments, the migration profile may further include application information retrieved by the cloud migration application from the application through a call through an application programming interface (API). In some embodiments, the method may further include displaying, through a connection to a user interface of the client device, a migration architecture. In some embodiments, the cloud migration application may embed the vector in the prompt. In some embodiments, the migration profile may include a key-value pair that represents an application information retrieved from the application and a selected value.

In some embodiments, the techniques described herein relate to a method including: extracting, by a cloud migration application executed by a computer, application data of an application to be migrated from the computer to a cloud based platform from one or more internal APIs; receiving, by the cloud migration application, a text input to a machine learning model executed by one or more processors, the text input comprising a context; generating, by the cloud migration application, a prompt including a corpus of text based documents and a blueprint for migration including the context as an embedding; providing, by the cloud migration application to the machine learning model, the prompt and the blueprint; generating, by the machine learning model, a search for a private vector database for a database document similar to the corpus of text documents based on a vector representation of the corpus of text documents compared to the database document or a sentence transformer of the input text compared to the database document; providing, by the machine learning model, the database document and the vector representation to the cloud migration application; receiving, at the cloud migration application and from the machine learning model, an executable script based on the blueprint for migration, the database document, and the vector representation; and executing, by the cloud migration application on the client device, the executable script to migrate the application from the computer to the cloud based platform.

The method may comprise wherein the context includes a public cloud capability and one or more constraints. The method may comprise wherein the context is an infrastructure of the application and is derived from the text input including a pattern identified from the text input, the pattern comprising a type of application to be migrated, a migration source, a migration destination, a bandwidth, and a number of processors to execute the migration. The method may comprise wherein the type of application is one or more of or a combination of a data retrieval application, a data storage application, a multimedia application, a simulation application, an application including or referencing one or more third party applications, an application referencing external resources, and an application referencing more than a threshold number of internal network computers. The method may comprise further include displaying, through a connection to a user interface of the client device, a migration architecture. The method may comprise wherein the context is derived with a retrieval-augmented generation. The method may comprise wherein the migration profile includes a key-value pair that represents an application information retrieved and generated from the application and a fixed key and associated JSON syntax.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for cloud migration with artificial intelligence, in accordance with embodiments.

FIG. 2 is a method for cloud migration with artificial intelligence, in accordance with embodiments.

FIG. 3 is a block diagram of a computing device for implementing certain aspects of the present disclosure.

### DETAILED DESCRIPTION

Aspects generally relate to systems and methods for cloud migration with artificial intelligence.

Disclosed are systems and methods including a large language model (“LLM”) and multi-agent framework that includes specialized artificial intelligence (“AI”) agents that analyze software infrastructure projects, selects an optimal migration pattern, creates and implements the migration pattern for an application, and validates the application using functional testing. The LLM will assess and increase resiliency of the application through the analysis.

When current systems are used to migrate an application, refactoring large codebases in response to updates in underlying library dependencies is a large challenge. Disclosed systems and methods include an AI agent that may refactor a codebase and review the refactoring until one or more guidelines are met. Further, current systems and methods translate the large codebases from one high-level language to another slowly and painstakingly. Disclosed systems and methods include an AI agent that may provide an initial translation that is subsequently iterated upon to make the translated code modular and compliant with the one or more standards. Further AI agents may be invoked to generate unit-tests on the translated code to ensure correct translation and operation. By migrating to the cloud, further enablement process may be added to an application or made accessible by the application, but current systems rely on human expertise alone. Disclosed systems and methods include an AI agent that may parse internal and/or external documents to identify risks, detect preventive and corrective guardrails, provide guidance on necessary control, and/or generate test cases.

Disclosed systems and methods include generating, by an LLM, a migration strategy including one or more reference diagrams and/or links to documentation and testing the performance of the migration strategy implemented on an application.

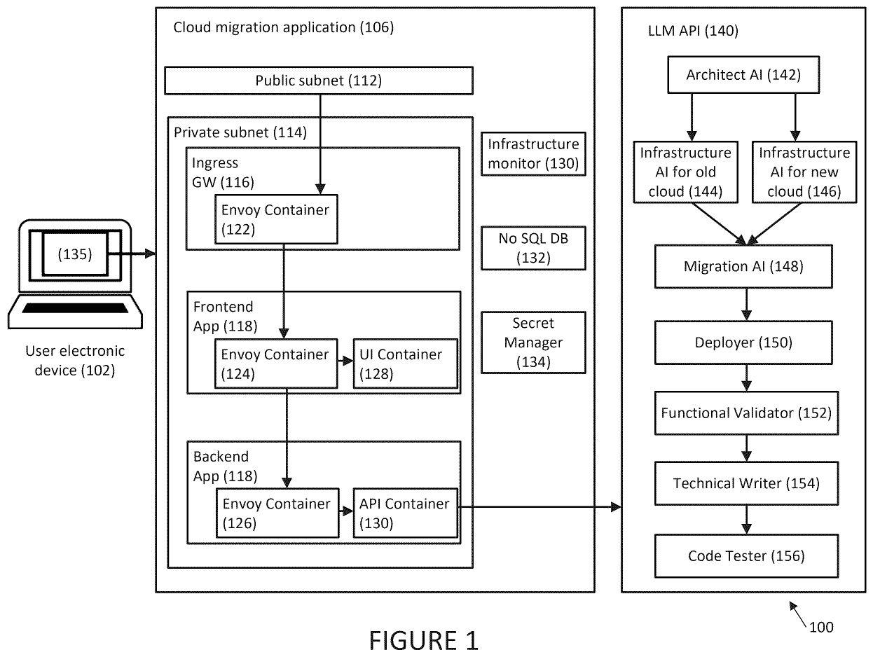

FIG. 1 is a block diagram of a system for dynamic configuration management, in accordance with embodiments.

System 100 includes a user electronic device 102 executing an cloud migration application 106 available through a user interface 135. Cloud migration application 106 may be executed on a network or computer including a processor executing one or more software modules and a memory for storing data accessible by the one or more software modules and instructions to execute the one or more software modules. Cloud migration application 106 may use application programming interfaces (“APIs”) to communicate with a code translation engine API 140. Cloud migration application 106 may include one or more software modules including one or more of public subnet 112, private subnet 114, infrastructure monitor 130, one or more databases including no SQL database 132, and secret manager 134.

Code translation engine API 140 may be a set of software components working together and executed by a server and/or a computer. The server may be part of an institution backend. The server may be part of a cloud-based server. In some embodiments, code translation engine API 140 may reference one or more databases that are cloud-based or part of a network or computer to store information including executable instructions of code translation engine API 140 and/or one or more software components.

In accordance with some embodiments, user electronic device 102 may be a user electronic device such as a personal communication device (e.g., tablet, phone), computer workstation, laptop, or other electronic processing device in operative communication with cloud migration application 106 and/or code translation engine API 140. User electronic device 102 may be configured to interact with cloud migration application 106 through user interface 135. For instance, user device 102 may include a client application that allows a user of user electronic device 102 to interact with cloud migration application 106. User interface 135 may include one or more graphical user interfaces to receive inputs and/or display information to the user. User interface 135 and/or cloud migration application 106 may comprise one or more instructions executed by one or more processors of user electronic device 102. Cloud migration application 106 may be a software production application provided by a service organization. In some embodiments, cloud migration application 106 may be an application configured to migrate a target application to a cloud from a local or on-premises network.

In some embodiments, cloud migration application 106 may receive a request in the form of a query from user interface 135. The query may include the application profile, location of a source for the application, and/or the application. Cloud migration application 106 may receive the request at a public subnet 112. The public subnet 112 may include a load balancer that is configured to distribute traffic, resulting in relatively even traffic distribution and efficient autoscaling. In some embodiments, request-level caching is implemented. Thus, input free text queries, prompts, and outputs are stored in a serverless, document, SQL database. This may minimize a number of API requests. In some embodiments, user feedback on generated outputs may be collected and used to assess performance and measure specific instances where performance is relatively low or insufficient.

Code translation engine API 140 may generate a migration profile. The migration profile may be a set of key-value pairs. The keys may reflect options of a recommended migration strategy. The keys may be “compute” or “database.” The keys may correspond to public cloud products. The keys may be Boolean values. The advantage may be that code translation engine API 140 may make model outputs easier to validate allow them to be used to generate output pragmatically. The migration profile may contain relevant keywords that are used in a document search discussed below. Code translation engine API 140 may input a list and explain each choice in a free-text field for review and/or for a check LLM to verify. The migration profile may be represented a JSON formatted string in the output from code translation engine API 140.

Code translation engine API 140 may be configured to autonomously generate novel code, migration code, functional test code, and a comprehensive user guide elucidating the entire migration process. Unlike traditional iterative methods, the decision-making process regarding iteration and looping back may be governed by a Large Language Model (LLM). The LLM may iterate until a variation between iterations is less than or equal to a threshold. Furthermore, the system integrates established software engineering and architectural practices to enhance the overall efficacy and robustness of the migration process. The user guide will include reasoning and detailed steps to explain the flow and make use of tools, code blueprints, and templates to increase the accuracy of the output.

Code translation engine API 140 may be trained on a text corpus that contains information about one or more cloud computing platforms. A prompt may be generated for code translation engine API 140, the prompt including a task and a context. Retrieval-augmented-generation methods may be used by cloud migration application 106 to generate the context. The context may refer to a number or set of text-based documents. The steps may reflect cited text-based documents. Code translation engine API 140 may generate a JSON string with one or more known schema by generating one or more values associated with particular keys while fixing the keys and associated JSON syntax. This may avoid errors compared to generating a full JSON string. However, multiple sequential API calls may be required for the improved LLM and LLM output.

Code translation engine API 140 may retrieve information from one or more of a number or set of text-based documents based on an input string. Cloud migration application 106 may generate the input string based on an identification of an application or a user input. The identification of the application (e.g., application profile) may include determining a name, cloud service type, a migration approach, and a number of regions. The name may be used by the code translation engine API 140 to extract application infrastructure information from an internal API. Code translation engine API 140 may use the extracted application identification to extract application specific information from an internal database. The extracted information may include the kind of services the tools application uses which informs the recommended migration strategy. The API will return information also formatted as a JSON string, which can be inserted in a prompt for code translation engine API 140.

The generated migration profile may be used to create additional outputs by cloud migration application 106. Diagrams may be generated from the migration profile that show a recommended cloud architecture created using a diagrams library. Cloud migration application 106 may generate a link that points to internal documentation on cloud products and recommended policy for a particular set of the steps. In some embodiments, the key-value pairs in the migration profile may be used to retrieve one or more portions of internal documentation from a database of documentation. In some embodiments, one or more sentence transformers may be used to create one or more compressed vector representations of the large amount of documentation in the database. Documents may be selected on a per query or per prompt basis based on a similarity between the vector representation of the documents and the prompt.

Code translation engine API 140 may be trained by requiring the LLM to select an answer from a list of valid options and correcting the LLM as needed. Since for each key there may only be a few valid values, the reconstruction accuracy of the migration profile key-value pairs was measured and used to assess model accuracy. An exception to this may be a free-text reasoning generated by code translation engine API 140. In addition to reconstruction accuracy two other important metrics may be measured: the latency, or time taken for the tool to return an output, and the number of tokens generated. The first may be important in terms of user experience and the latter may be used in this example as a proxy for the cost of the API call, since the cost typically scales as the number of tokens generated. Finally, experiments may be conducted with the LLM temperature set to 0 to minimize variation associated with the stochastic sampling in the text generation. Accuracy is measured as either an extract case insensitive string match or a Boolean match, depending on the expected value. The latency of a particular call may be a difficult parameter to measure since it largely depends on the behavior of the LLM API. Feedback and/or a check LLM may be used to correct and improve code translation engine API 140 based on a quality of the output.

Code translation engine API 140 may include a multi-agent framework to avoid having a LLM generate hallucinations and/or the same output each time. The multi-agent framework may include specialized task-based input and an ability to break up the task into multiple stages.

The agents of code translation engine API 140 may include an architect AI 142, an infrastructure AI for an old cloud 144, an infrastructure AI for a new cloud 146, a migration AI 148, a deployer 150, a functional validator 152, a technical writer 154, and a code tester 156. Each of the agents may be LLM invocations with their own custom prompts (including system prompts), few-shot examples and access to specific tools (such as knowledge bases, software development life cycle (“SDLC”) components, compilers etc.). When invoked, the agents may be able to use the tools available to them to generate results specific to their sub-task, which are then added to a process-wide memory (or state) and handed over to the next agent in the process. In order to further increase the reliability of these systems and reduce hallucinations, albeit at a potential reduction of cost of increased latency, supervision may be implemented for each of the steps. In such a LLM (a critic model setup) may be included to review and approve the intermediate outputs and decisions taken by some or all of the agents in the multi-agent setup. Any approved outputs from a particular agent can also, optionally, be added back to the list of few-shot examples provided to the agent for future invocations, forming a feedback loop for, among other things, reinforcing accurate responses.

Architect AI 142 may determine a location of code, one or more linked applications, and/or one or more linked resources of an application. The location may be an old cloud or network (e.g., a location to be migrated from where infrastructure AI for an old cloud 144) or a new cloud or network (e.g., a location to be migrated to where infrastructure AI for a new cloud 146). Migration AI 148 may test distinct portions of code of the application to determine whether migration will be successful including creating new links for resources, applications, and/or generating new code for the new cloud or network. Migration AI 148 may select an optimal migration pattern.

Deployer 150 may install and/or execute the application in the new cloud or network. Functional validator 152 may test one or more functions of the application in the new cloud or network. Technical writer 154 may store and manage the code of the application or portions of the code. Technical writer 154 may include a bug and/or issue tracking tool. Technical writer 154 may generate one or more APIs for third-party applications to be linked to the application. Code tester 156 may test the final installed application in the new location by feeding one or more inputs to the application.

In some embodiments, a LLM may be specifically trained for a task or to fine-tune the LLM. By enforcing agentic workflows to incorporate best software engineer practices such Behavior Driven Development (BDD), the level of trust in the output of LLM may be improved by continuously assessing agent performance and functionality throughout the development. The focus of behavior and outcomes of code translation engine API 140 may generally result in code becoming more modular, clearer and higher quality. In the example of our cloud migration project, we want to ensure that the business requirements are still being met as the migration occurs so having this mechanism becomes critical.

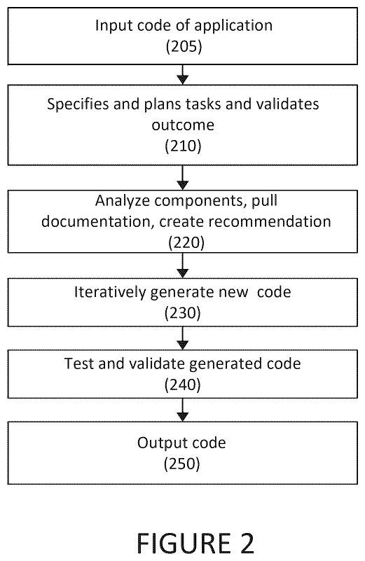

FIG. 2 is a method for cloud migration application, in accordance with some embodiments. The method may be stored as a list of instructions stored on a memory that when executed by one or more processors cause the one or more processors to perform the method.

Step 205 may include receiving, through a cloud migration application, an input code of an application, a location of the application, or an application profile of the application.

Step 210 may include adding, by the cloud migration application, a role to a first artificial intelligence migration agent to modify the application, determining an application source code for the application, one or more resources used or linked by the application, one or more third party applications used or linked by the application. The cloud migration application may specify and plan one or more tasks for the AI migration agent. In some embodiments, a validation agent may validate the determinations of the cloud migration application using a stored application as a template. In some embodiments, the validation agent may be a machine learning model that determines the stored application based on a semantic similarity of one or more phrases or code lines with the stored application, thus identifying a stored application similar to the identified application and mirroring a migration pattern of the stored application. Instructions may be generated as a blueprint by the AI migration agent including a sequence of migration (e.g., which application module to migrate at which time in a series of migration steps, which migration steps to execute in what order), based on the identified stored application and fed to the AI migration agent.

Step 220 may include generating, by the cloud migration application, a second artificial intelligence migration agent with the identified blueprint for the identified new application location.

Step 230 may include deploying, by the cloud migration application, the application to the new application location, which may be cloud-based. Deploying may include replicating the first artificial intelligence migration agent to the new environment.

Step 240 may include testing and validating, by a code tester, the generated code in the new environment. Testing and validating may be performed during migration for segments of code of the application (e.g., in batches). Code of the application may be iteratively tested by the code tester once migration is finalized in segments and/or as a whole.

Step 250 may include executing the application, by the cloud migration application, in the new location and thus ensuring functionality of the application. If not, one or more steps may be repeated and/or the one or more AIs may be instructed that the migration was not completed.

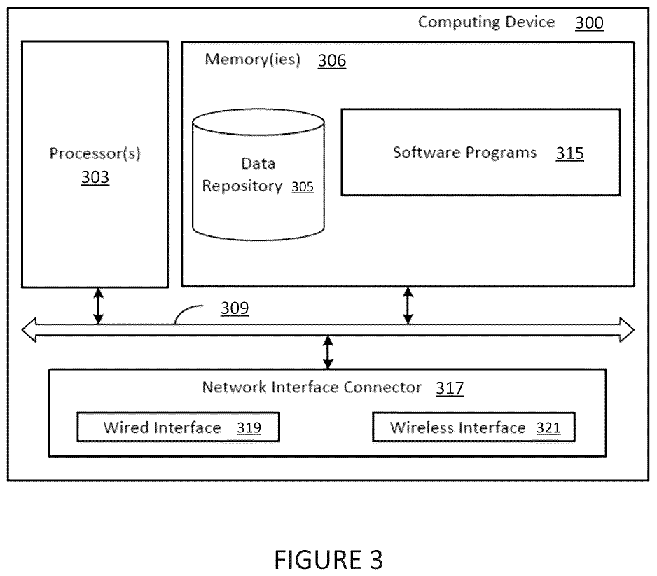

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
extracting, by a cloud migration application executed by a computer, application data of an application to be migrated from the computer to a cloud based platform from one or more internal APIs;
receiving, by the cloud migration application, a text input to a machine learning model executed by one or more processors, the text input comprising a context;
generating, by the cloud migration application, a prompt including a corpus of text based documents and a blueprint for migration including the context as an embedding;
providing, by the cloud migration application to the machine learning model, the prompt and the blueprint;
generating, by the machine learning model, a search for a private vector database for a database document similar to the corpus of text documents based on a vector representation of the corpus of text documents compared to the database document or a sentence transformer of the input text compared to the database document;
providing, by the machine learning model, the database document and the vector representation to the cloud migration application;
receiving, at the cloud migration application and from the machine learning model, an executable script based on the blueprint for migration, the database document, and the vector representation; and
executing, by the cloud migration application on the client device, the executable script to migrate the application from the computer to the cloud based platform.

2. The method of claim 1, wherein the context includes a public cloud capability and one or more constraints.

3. The method of claim 1, wherein the context is an infrastructure of the application and is derived from the text input including a pattern identified from the text input, the pattern comprising a type of application to be migrated, a migration source, a migration destination, a bandwidth, and a number of processors to execute the migration.

4. The method of claim 3, wherein the type of application is one or more of or a combination of a data retrieval application, a data storage application, a multimedia application, a simulation application, an application including or referencing one or more third party applications, an application referencing external resources, and an application referencing more than a threshold number of internal network computers.

5. The method of claim 1, further including displaying, through a connection to a user interface of the client device, a migration architecture.

6. The method of claim 1, wherein the context is derived with a retrieval-augmented generation.

7. The method of claim 1, wherein the migration profile includes a key-value pair that represents an application information retrieved and generated from the application and a fixed key and associated JSON syntax.

8. A computer processing system comprising:
a memory configured to store instructions; and
a hardware processor operatively coupled to the memory for executing the instructions to:
extracting, by a cloud migration application executed by a computer, application data of an application to be migrated from the computer to a cloud based platform from one or more internal APIs;
receiving, by the cloud migration application, a text input to a machine learning model executed by one or more processors, the text input comprising a context;
generating, by the cloud migration application, a prompt including a corpus of text based documents and a blueprint for migration including the context as an embedding;
providing, by the cloud migration application to the machine learning model, the prompt and the blueprint;
generating, by the machine learning model, a search for a private vector database for a database document similar to the corpus of text documents based on a vector representation of the corpus of text documents compared to the database document or a sentence transformer of the input text compared to the database document;
providing, by the machine learning model, the database document and the vector representation to the cloud migration application;
receiving, at the cloud migration application and from the machine learning model, an executable script based on the blueprint for migration, the database document, and the vector representation; and
executing, by the cloud migration application on the client device, the executable script to migrate the application from the computer to the cloud based platform.

9. The system of claim 8, wherein the context includes a public cloud capability and one or more constraints.

10. The system of claim 9, wherein the context is an infrastructure of the application and is derived from the text input including a pattern identified from the text input, the pattern comprising a type of application to be migrated, a migration source, a migration destination, a bandwidth, and a number of processors to execute the migration.

11. The system of claim 10, wherein the type of application is one or more of or a combination of a data retrieval application, a data storage application, a multimedia application, a simulation application, an application including or referencing one or more third party applications, an application referencing external resources, and an application referencing more than a threshold number of internal network computers.

12. The system of claim 8, further including displaying, through a connection to a user interface of the client device, a migration architecture.

13. The system of claim 8, wherein the context is derived with a retrieval-augmented generation.

14. The system of claim 8, wherein the migration profile includes a key-value pair that represents an application information retrieved and generated from the application and a fixed key and associated JSON syntax.

15. A non-transitory computer readable storage medium, including instructions stored thereon, which when read and executed by one or more computer processors, cause the one or more computer processors to perform steps comprising:
extracting, by a cloud migration application executed by a computer, application data of an application to be migrated from the computer to a cloud based platform from one or more internal APIs;
receiving, by the cloud migration application, a text input to a machine learning model executed by one or more processors, the text input comprising a context;
generating, by the cloud migration application, a prompt including a corpus of text based documents and a blueprint for migration including the context as an embedding;
providing, by the cloud migration application to the machine learning model, the prompt and the blueprint;
generating, by the machine learning model, a search for a private vector database for a database document similar to the corpus of text documents based on a vector representation of the corpus of text documents compared to the database document or a sentence transformer of the input text compared to the database document;
providing, by the machine learning model, the database document and the vector representation to the cloud migration application;
receiving, at the cloud migration application and from the machine learning model, an executable script based on the blueprint for migration, the database document, and the vector representation; and
executing, by the cloud migration application on the client device, the executable script to migrate the application from the computer to the cloud based platform.

16. The non-transitory computer readable storage medium of claim 15, wherein the context includes a public cloud capability and one or more constraints.

17. The non-transitory computer readable storage medium of claim 15, wherein the context is an infrastructure of the application and is derived from the text input including a pattern identified from the text input, the pattern comprising a type of application to be migrated, a migration source, a migration destination, a bandwidth, and a number of processors to execute the migration.

18. The non-transitory computer readable storage medium of claim 17, wherein the type of application is one or more of or a combination of a data retrieval application, a data storage application, a multimedia application, a simulation application, an application including or referencing one or more third party applications, an application referencing external resources, and an application referencing more than a threshold number of internal network computers.

19. The non-transitory computer readable storage medium of claim 15, further including displaying, through a connection to a user interface of the client device, a migration architecture.

20. The non-transitory computer readable storage medium of claim 15, wherein the context is derived with a retrieval-augmented generation.
